(19) United States
(12) Patent Application Publication
(10) Pub. No.: US 2006/0235723 A1
(43) Pub. Date: Oct. 19, 2006

(54) System and method for management of content associated with digital distribution and updatable storage media

(76) Inventor: Steve Millard, Sydney (AU)

Correspondence Address: CARR & FERRELL LLP, 2200 GENG ROAD, PALO ALTO, CA, 94303, US

(21) Appl. No.: 11/452,543

(22) Filed: Jun. 13, 2006

Related U.S. Application Data
(63) Continuation-in-part of application No. 10/469,623, filed on May 6, 2004.
(60) Provisional application No. 60/690,457, filed on Jun. 13, 2005.

(30) Foreign Application Priority Data
Feb. 20, 2001 (AU) PR3217
Feb. 20, 2002 (WO) PCT/AU02/00172

(51) Int. Cl. G06Q 99/00

(52) U.S. Cl. 705/1

(57) ABSTRACT

A system and method for accessing and managing digital content associated with updatable storage media is provided. An exemplary management engine is initially installed onto a user computing device where the updatable storage media is utilized. The exemplary management engine comprises a content interface module which works in conjunction a library interface module and a download module to present the user with a management user interface for accessing currently stored content and new, available content which may be downloaded onto the user computing device. User preferences may be accessed by a settings module in order to customize the management user interface and interactions.

### CROSS-REFERENCES TO RELATED APPLICATIONS

The present application is a continuation-in-part application of U.S. patent application Ser. No. 10/469,623 filed Aug. 20, 2003 and entitled “System and Method for Licensing Content on Updatable Storage Media,” which claims the benefit of Australian Provisional Patent Application Serial No. PR3217, filed on Feb. 20, 2001, entitled “Method of Licensing Content on Updatable Digital Media,” by way of PCT Application No. PCT/AU02/00172 filed Feb. 20, 2002; the present application also claims the priority of the U.S. Provisional Patent Application No. 60/690,457, filed Jun. 13, 2005 and entitled “Management of Updatable Storage Media,” all of which are incorporated herein by reference.

### BACKGROUND OF THE INVENTION

1. Field of the Invention

The present invention relates generally to digital distribution of content, and more particularly to management of content associated with updatable storage media.

2. Description of Related Art

Distribution of content in the form of data, music, video, or other forms of information via collectable digital media is becoming increasingly popular. Collectable digital media include Compact Disk (CD), Digital Versatile Disk (DVD), DVDplus, Dual Disc and all present and future versions of optical disc media, minidisks, and memory sticks. Advantageously, these collectable media allow users to access content that is tailored to the user's specific interests. As a further advantage, industries such as the music industry, are able to promote the collectable media (e.g., CD of an album).

This collectable mentality is fundamentally important to certain industries. For example, evolution of convergent technologies such as broadband Internet may be a threat to long-term existence of music and other similar industries (e.g., downloading and recording of music over the Internet poses a serious threat to sales of music CDs). The threat exists because the music industry relies primarily on manufacture, distribution, and sale of collectable media such as CDs, DVDs, and all other forms of optical disc media and minidisks.

Traditional CD and DVD disks contain historical content as the disk is manufactured as read-only media. The content can only be read from the media and played by a respective device compatible with the media. Thus, when the user acquires the CD or DVD, the content could, conceivably, be several years in the making and outdated.

Writable disk media are also readily available to users. This medium allows the user to create a digital clone of content on any optical disk, but does not give the user the collectable images and options that would normally be provided with the purchase of an original collectable media. The writable disk media does not, however, give users the right to infringe copyright or other legal rights in making the digital clone of the original collectable media. This is most prevalent in digital media as each copy is, itself, a master.

Therefore, there is a need for a system and method which allows users to access, to download and to record content to updatable storage media and to protect all licensing requirements of relevant industries. There is a further need to efficiently and easily manage access, recording, and maintenance of the content on the updatable storage media and associated computing devices.

### SUMMARY OF THE INVENTION

An exemplary system and method for management of collectable digital content associated with updatable storage media is provided. An exemplary management engine is initially stored onto a user computing device upon a first use of the updatable storage media (e.g., an enhanced media device or disk). The exemplary management engine comprises a content interface module, a settings module, a library interface module, a download module, transfer module, and a burn module. The management engine may further comprise a network configuration module and payment gateway module.

The content interface module works in conjunction with the library interface module to present the user with a management user interface for accessing currently stored content in a media player of the user computing device. In one embodiment, the library interface module accesses a storage device of the user computing device to find content associated with a current artist or content selection.

The download module works with the content interface module 302 to provide an interface for access to new, available content which may be downloaded onto the user computing device, the associated updatable storage media, or both. The download process includes an ability to preview content prior to purchase, select a proper format type for download, and select payment options.

User preferences may be accessed and changed by a settings module in order to customize the management user interface on the user computing device. The preferences may further assist in efficiently accessing and managing digital content. For example, the preferences may contain credit card information for the user which will be automatically utilized by a payment gateway module during a purchase process.

The present invention may be utilized in various industries such as music, film, and television and may be embodied on various media such as DVD storage media, CD storage media, BlueRay DVD, high definition DVD, and hybrid optical disk media. Further, the present invention may be practiced on hard disks or other storage media formats.

### BRIEF DESCRIPTION OF THE DRAWINGS

FIG. 1 is an exemplary environment where the present invention may be practiced;

FIG. 2 is a detailed block diagram of an exemplary enhanced media disk operating on a computing device;

FIG. 3 is a block diagram of an exemplary management engine

FIG. 4A-FIG. 4E are example screenshots of enhanced media content presented to a user;

FIG. 5A-FIG. 5K are example screenshots of a management user interface for determining availability and downloading of new content;

FIG. 6A-FIG. 6B are example screenshots of library features of the management user interface;

FIG. 7 is an alternative example of a selected media; and

FIG. 8 is an example of shipment tracking.

### DETAILED DESCRIPTION OF EXEMPLARY EMBODIMENTS

The present system and method overcomes or substantially alleviates present limitations associated with collectable digital media and content. Exemplary embodiments of the present invention provide a system including a management user interface for accessing and managing digital content associated with digital distribution and updatable storage media.

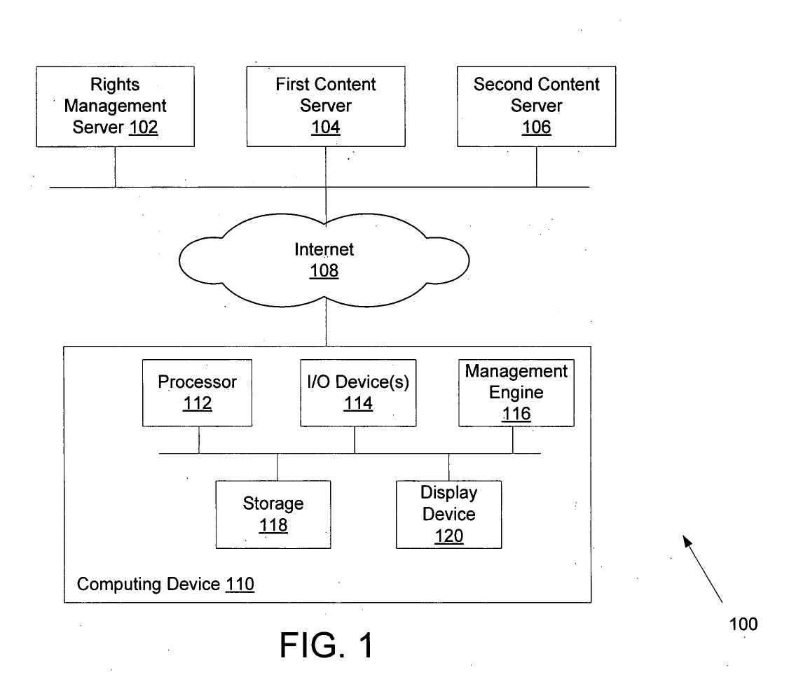

In FIG. 1, an exemplary environment 100 in which embodiments of the present invention may be practiced is shown. The exemplary environment 100 comprises a rights management server 102, a first content server 104, and an optional second content server 106 coupled to the Internet 108. A user computing device 110 is also coupled to the Internet 108. In alternative embodiments, the environment 100 comprises a plurality of user computing devices 110 simultaneously coupled to the Internet. Although two content servers 104 and 106 are shown, any number of content servers 104 may be present in the environment 100. In alternative embodiments, the various functions of the rights management server 102 may also be incorporated into the content servers 104 and 106, thus eliminating the need for a separate rights management server 102. In a further embodiment, a payments validation/approval server may also be provided.

The user computing device 110 further comprises a processor 112, I/O devices 114, a management engine 116, a storage device 118, and a display 120. The I/O devices 114 may include different media drives/connections, network interfaces, and any other device which provides data transfers into and out of the user computing device 110. For example, the user computing device 110 may be coupled to the Internet 108 by a broadband connection via a network interface I/O device.

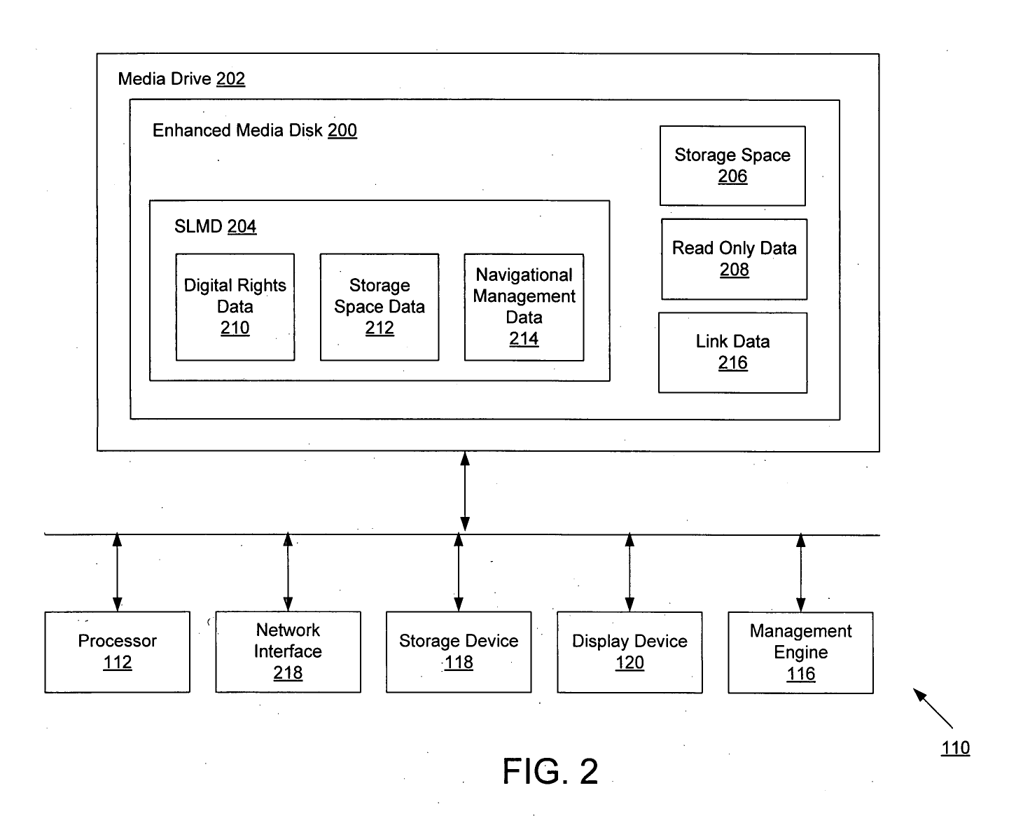

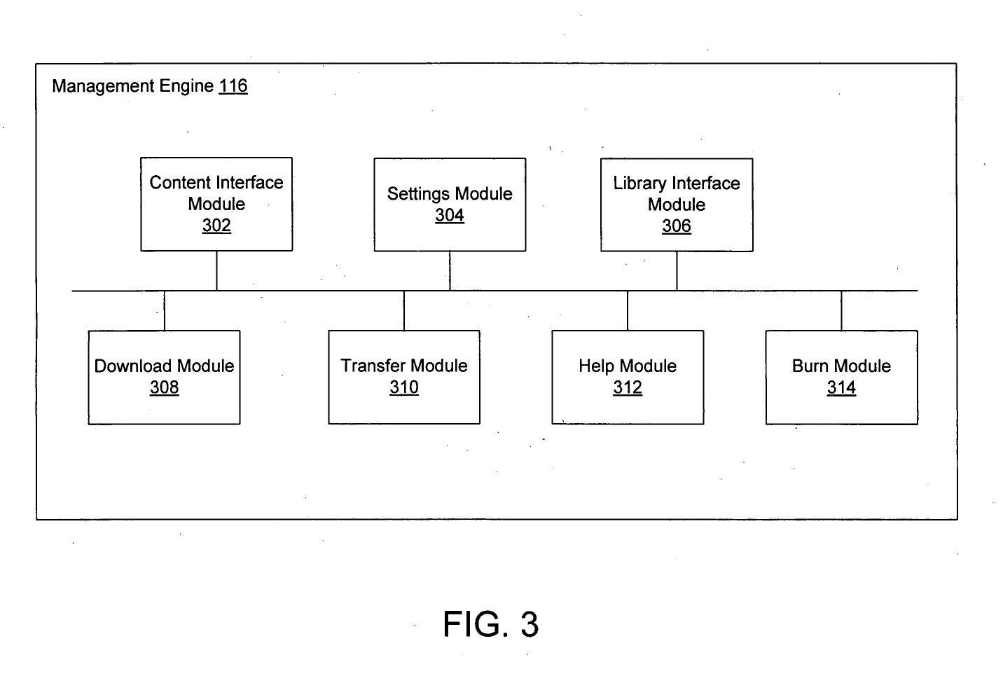

According to exemplary embodiments, the management engine 116 component is initially downloaded and installed into the user computing device 110, from the updateable storage media, the first time a user uses an enhanced, updatable storage media (e.g., an enhanced media disk such as an enhanced CD or enhanced DVD) on the user computing device 110. Ideally, the updatable storage media is presented to the user computing device 110 via one of the I/O devices 114. The updatable storage media will be discussed in more detail in connection with FIG. 2, while the management engine 116 will be discussed in more detail in connection with FIG. 3. In a further embodiment, the updatable storage media may be a digital download (i.e., without a physical disk) that functions similarly to a disk version—that is a first download of a digital content from an enhanced content server (e.g., content server 104) will provide both the desired digital content and the management engine 116 component to the downloading computing device (e.g., user computing device 110). In some embodiments, the management engine 116 component is stored in the storage device 118.

In exemplary embodiments when new content is released or when the user desires to store new content of his choosing either on their storage device 118 or onto the updatable storage media (e.g., disk), the user computing device 110 via management engine 116 negotiates with the rights management server 102. The exemplary updatable storage media, when purchased will contain various storage media licensing data (SMLD). The SMLD allows the purchaser of the enhanced media (i.e., updatable storage media) to access, and in some cases, to download and store additional content related to the updatable storage media as defined by the terms and conditions of the SMLD. Thus, the management engine 116 will, using the SMLD, negotiate with the rights management server 102 to access the new content stored at one of the content servers 104 or 106. Assuming the SMLD contains license rights to the new content, the rights management server 102 will allow access to the new content. Alternatively, the management engine 116 may use the SMLD to negotiate terms of a new license agreement for the desired content. Negotiation of new terms may involve paying a license fee for the desired content.

Referring now to FIG. 2, an exemplary block diagram of an enhanced, updatable storage media in operation with the user computing device 110 is shown. In the present example, the updatable storage media is an enhanced media disk 200 (e.g., enhanced CD or DVD). The enhanced media disk 200 is read by a media drive 202 of the user computing device 110. In one embodiment, the enhanced media disk 200 comprises a SMLD area 204, updatable storage area 206, and read-only data area 208. The updatable storage area 206 is a portion of the enhanced media disk 200 where new content is stored while the read-only data area 208 includes pre-recorded content. In exemplary embodiments, the SMLD and contents of the enhanced media disk 200 are downloaded onto the user computing device 110 so that future access of the SMLD or associated content may occur without the presence of the enhanced media disk 200 in the user computing device 110. The downloaded data may be stored in the storage device 118 and managed by the management engine 116.

As described above, the SMLD area 204 contains the SMLD for the particular enhanced media disk 200 and associated content. The SMLD area 204 may further comprise digital rights data 210, storage space data 212, and navigational management data 214. The digital rights data 210 includes license rights or the ability to negotiate license rights to new content on the content servers 104 and 106 (FIG. 1). The storage space data 212 provides instruction on where in the storage area 206 to write new content. In one embodiment, the storage space data 212 includes bit budgeting management whereby storage area 206 is checked against incoming content data size and ensured data integrity. The navigational management data 214 provides instructions to create/update menus from which the user can access the new content along with pre-existing content. While the storage space data 212 and navigational management data 214 are shown as part of the SMLD area 204, alternative embodiments may store these data 212 and 214 outside of the SMLD area 204.

In one embodiment, the enhanced media disk 200 further comprises link data 216. This link data 216 may, in some embodiments, be stored in the read only area 208 or elsewhere on the enhanced media disk 200. The exemplary link data 216 comprises web links to various Internet sites including the content servers 104 and 106, which are accessed via a network interface 218. The data link 216 may also be downloaded onto the user computing device 110 and stored in the storage device 118 for local access.

It should be noted that the enhanced media disk 200 is exemplary. In alternative embodiments, the updatable storage media may be blank—that is the enhanced media disk 200, for example, will contain SMLD data for additional content and the management engine 116 component which is downloadable to the user computing device 110, but no pre-recorded content will be initially located on the enhanced media disk 200.

In exemplary embodiments, the enhanced media disk 200 (and updatable storage media, in general) comprises three distinct technology layers. The first layer is a ‘low level interface’ which handles tasks such as disk writing/burning and some Internet functions. The second layer is a content management interface layer which handles downloading of new content, organizing the content, purchase of content, and providing an interface for disk recording and maintenance. The final layer is a content interface layer. The content interface layer handles all functions related to presentation of content on the disk 200 including animation, video, graphics, and sounds which are the results of the unique content provided by the content author/artist. Because the content and content management interface layers function separately, transactions, updates, and management are secure and separate from any designs or programming from the content author/artist.

As previous described, when the enhanced media disk 200 is first loaded into the user computing device 110, all the contents including the data from the SMLD area 204 are loaded onto the storage device 118 (e.g., a hard drive) via the management engine 116. Any subsequent access to the associated content on the user computing device 110 may be, for example, via the storage device 118.

In exemplary embodiments, the user computing device 110 periodically or based on events (e.g., activation by the user), checks the Internet (e.g., content servers 104 and 106) for updates or upgrades. This ensures that the modules and contents on the user computing device 110 (and the associated updatable storage media) are up to date. In some embodiments, the check occurs in background, so the user does not see any indication that the check is occurring unless a large update is necessary. In an alternative embodiment, the content provider can push updates or notifications of available updates to the user. For example, the content provider can send updates or notification of updates available via e-mail, SMS message, or other forms of desktop messaging.

Embodiments of the present invention allow a content provider or media distributor to track content and updatable storage media. In exemplary embodiments, the tracking is facilitated by a CRM (consumer retail management system) application within the management engine 116. Activities of users, such as purchase of content, along with demographics and locations can be tracked. This information may then be used for marketing or other purposes by the content provider or media distributor. For example, if sales of a particular downloadable song are high in one geographic location, marketing can be customized to take advantage of this information.

Referring now to FIG. 3, an exemplary management engine 116 is shown. The management engine 116 is originally downloaded and stored onto the user computing device 110 (FIG. 1) when a first updatable storage media is presented to the user computing device 110. The management engine 116 needs to be installed only once onto the user computing device 110, although subsequent updates may be available either via future updatable storage media or via the Internet 108 (e.g., from the rights management server 102 or the content servers 104 and 106 of FIG. 1).

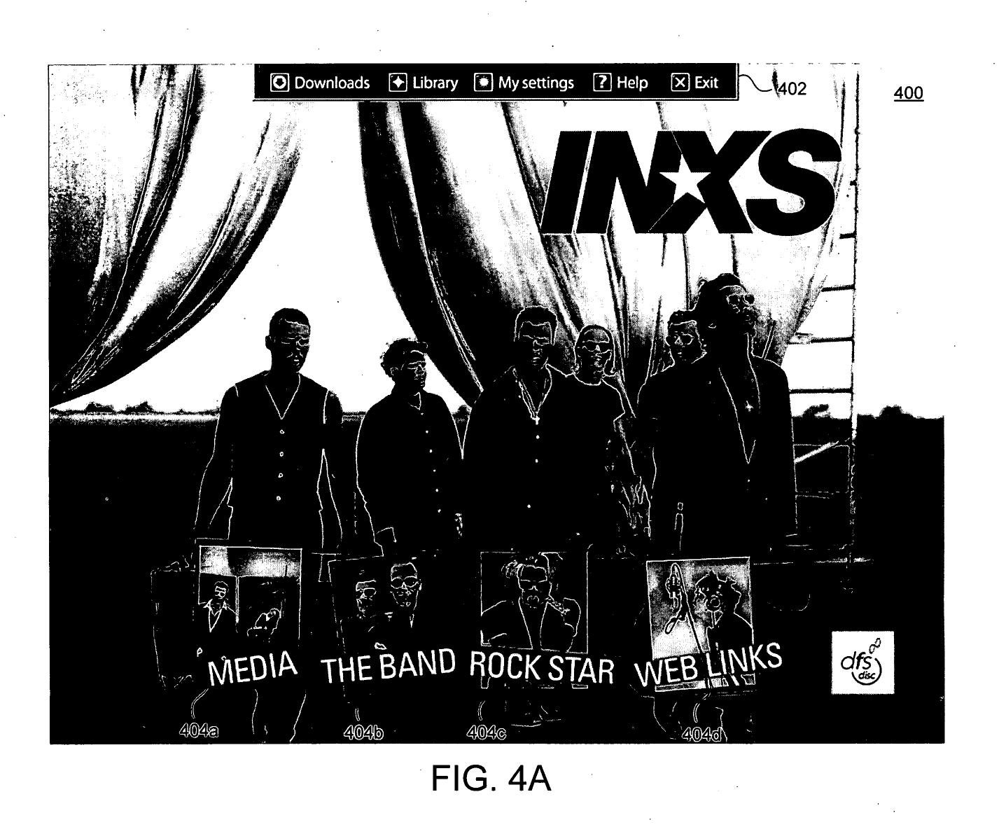

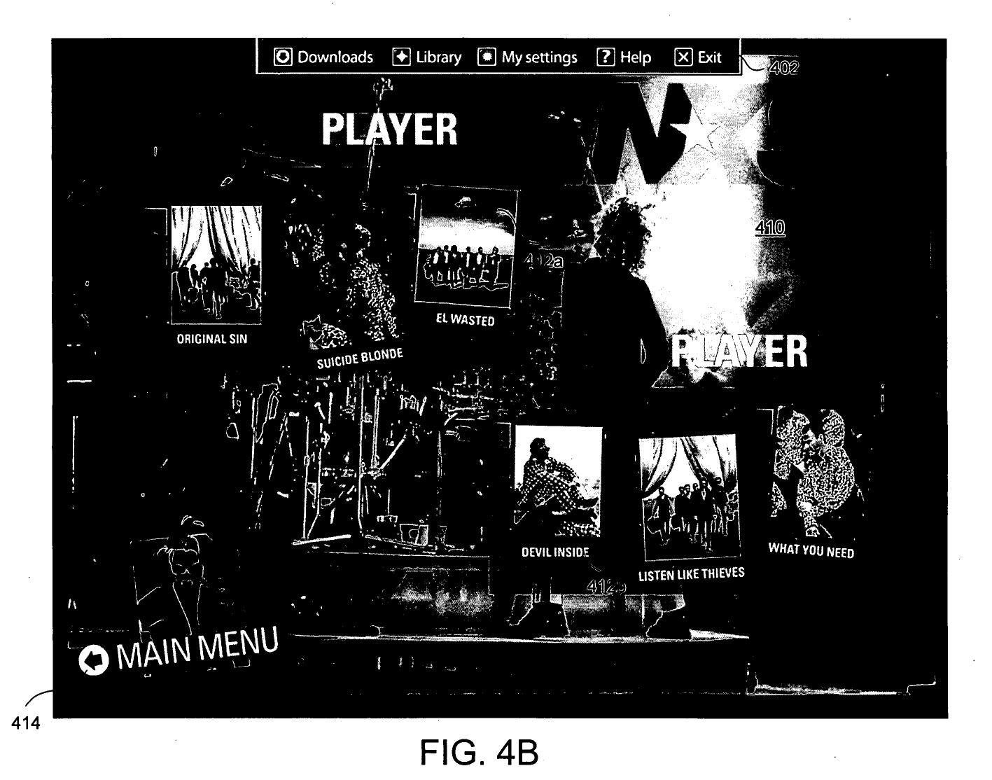

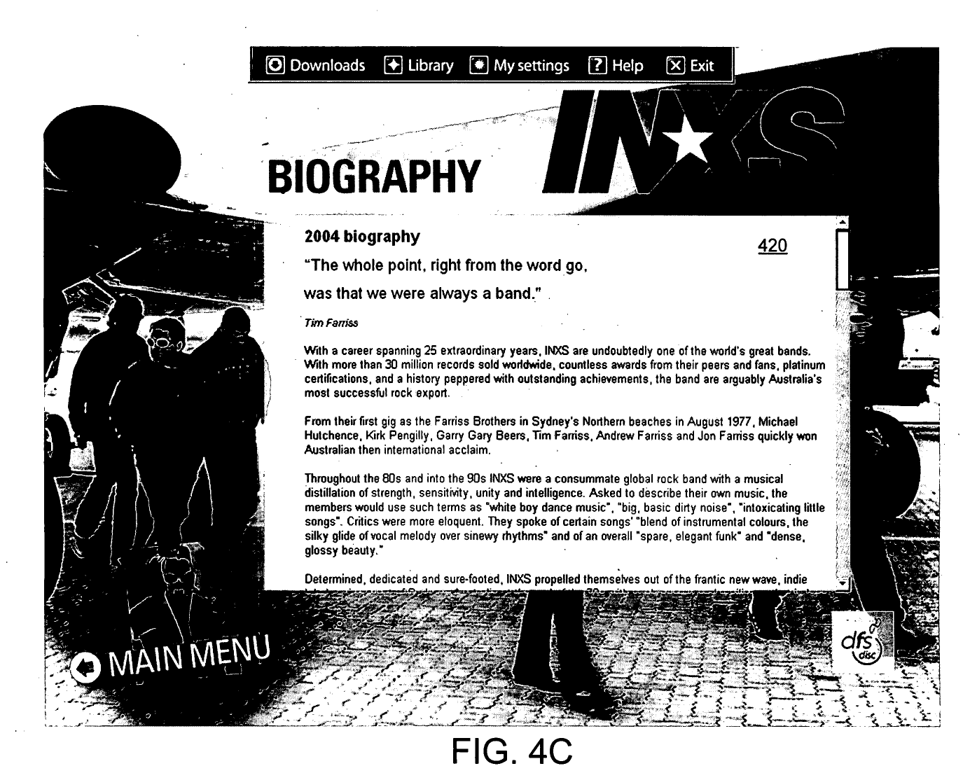

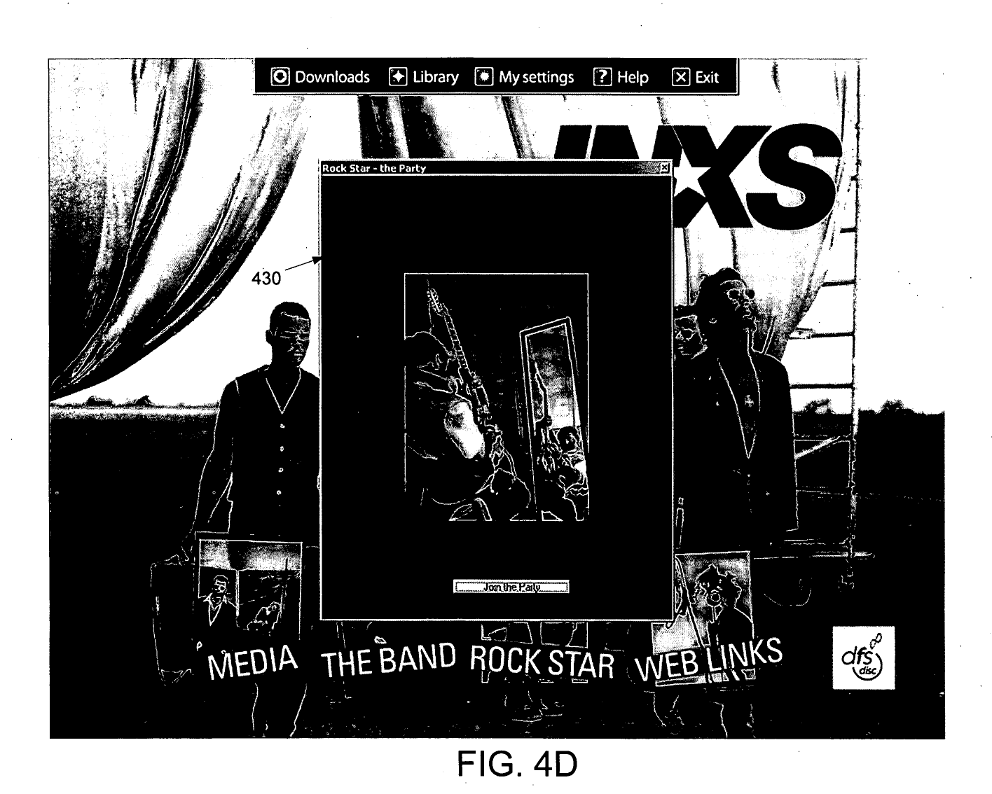

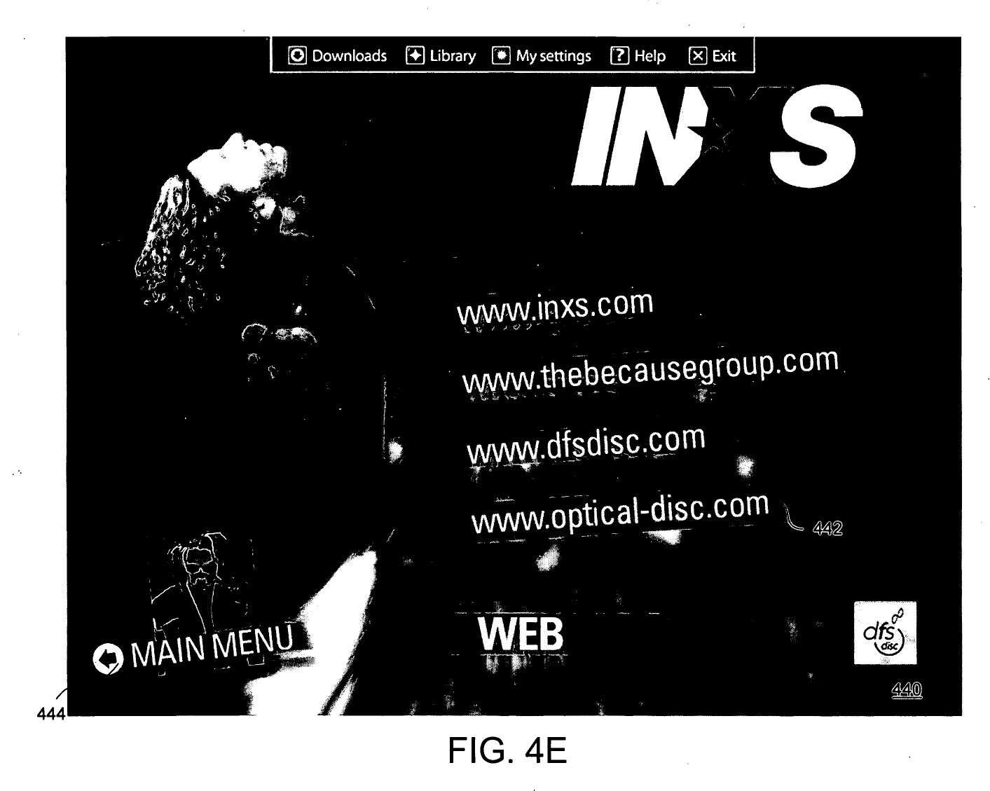

In exemplary embodiments, the management engine 116 comprises a content interface module 302, settings module 304, library interface module 306, download module 308, transfer module 310, help module 312, and a burn module 314. In alternative embodiments, more or fewer modules may be present in the management engine 116 and/or that some of the modules may be located elsewhere in the user computing device 110. For example, a payment gateway module may work with the settings module 304 to deliver payment for content. This payment gateway module may store payment information in a secured setting (e.g., password protected) which may be used to automatically populate payment fields. In a further example, a network configuration module may be provided. While a brief description of each module is subsequently provided, some modules will be discussed in additional detail in conjunction with the various screenshots of FIG. 4A-FIG. 8.

The exemplary content interface module 302 provides graphics for display on the display device 120 (FIG. 1). For example, when a user initiates a media player on their user computing device 110, the content interface module 302 provides artist content such as introductory animation. The user is then presented a management user interface through which the user may navigate through stored content in order to experience the content. Examples of content experiences include hearing music, viewing a video or movie, reading background information, viewing sports statistics, playing a video game, and so forth.

The settings module 304 allows the user to personalize the management user interface of the media player. In further embodiments, the settings module 304 accesses and uses stored user data. For example, the user's credit card information may be accessed in order to expedite purchase of additional content. Additionally, the preferred audio and video formats may be accessed by the settings module 304.

The library interface module 306 accesses and manages an associated library of content stored on the user computing device 110 (e.g., storage device 118). The user may rename, rearrange, or delete “tracks” stored in the library. The library interface module 306 works with the content interface module 302 to present various library data to the user. The library interface module 306 further works with the download module 308 to prepare an ordered list of tracks to record onto the associated updatable storage media.

The exemplary download module 308 allows the user to download and store new content to their user computing device 110. When a user checks for new or updated content, the download module 308 matches a unique disk identification number from the associated updatable storage media (e.g., from the SMLD 204 of FIG. 2) and checks the Internet for new or updated content (e.g., new music track or new sports video segment). A list of new content is presented to the user, and the user may select “tracks” from the list to preview the content. For example, the disk identifier activates and accesses an appropriate content provider (e.g., first or second content severs 104 or 106) for updates. The appropriate content provider will then check for updates and presents new titles via the management user interface provided by the content interface module 302 for the user to consider. The user may further choose to buy or download the full content at their discretion. Some tracks may be free, offered as part of a bonus or loyalty scheme, while others must be purchased. In some embodiments, the user may have pre-paid for tracks with the purchase of the corresponding updatable storage media.

Once new content (e.g., one or more tracks) is downloaded and stored on the user computing device, the library will be updated to include the new content. Additionally, the user may now download and store (i.e., burn) the new content onto the corresponding updatable storage media by activating the burn module 314. By storing content onto the updatable storage media, a “hard copy” of the content is saved. In an alternative embodiment, the user may elect to automatically download the new content to their updatable storage media. Once the new content is stored onto the user computing device 110, the user computing device 110 can record the new content to the updatable storage media with or without any user intervention. In yet a further embodiment, the new content may be downloaded and stored directly onto the updatable storage media without storage to the user computer device 110.

The transfer module 310 allows a user to transfer content to other hardware devices within the user's designated hardware home universe (HHU). In exemplary embodiments, the user will “load” a plurality of their home hardware devices into the HHU via a HHU field provided by the management engine 116. In one embodiment, a HHU identifier is loaded into the management engine 116 via the settings module 304. The HHU identifier may be a unique identifier, a barcode number, model number, or any other unique method of identifying a particular device. The hardware devices in the HHU may comprise MP3 players, car stereos, media centers, mobile phones or devices, personal computing devices, PDAs, and/or any other computing devices capable of providing audio, video, or a combination of both. By identifying their HHU, exemplary embodiments will allow the user the flexibility to move various digital contents around their home within the HHU. In some embodiments, the digital content may be moved as often as the user desires. The digital content may be moved via any form of communication such as, for example, e-mail, disk transfer, storage device transfer (e.g., a USB flash drive). If, however, the user moves digital content outside of the HHU, digital rights management will activate and the user will have a limited number of times (e.g., three) to play the content before a new license is required (i.e., user must purchase the content). It should be noted that hardware devices, as described above, may include any computing devices.

In some embodiments, the transfer module 310 provides a simplified user interface that easily transfers selected content to selected hardware devices in the HHU. For example, a list of available HHU devices is provided, and the user merely selects (e.g., checks a box) the device(s) to which content is to be copied. Additionally, a list of files/tracks is presented to the user from which the user selects from to transfer. The transfer module 310 then automatically determines a proper format type, converts the file(s) to the proper format, and sends the file to the coupled hardware device(s). For example, the file may be sent via e-mail, the Internet, wireless connections (e.g., Bluetooth), or any other wired, unwire, or Infrared connection to the hardware device(s).

In a further embodiment, if the user wants to send the file to a ‘new generation’ car media center, PDA, or phone, the transfer module 310 will guide the user through the process. Additionally, the transfer module 310 may offer to print out a guide so the user can complete the transfer process on the associated hardware device.

In a situation where the user sends protected content (i.e., license required content) to a non-HHU device, the transfer is still allowed to occur, however, the receiving device will only have a limited number of opportunities to utilize the content. For example, a receiving non-HHU MP3 player may only be able to play a music track three times before a license is required for further play. An invitation for purchase of a new license will activate from the actual transferred file/content—that is the new license invitation is embedded in the transferred file/content. Automatically, after three plays or a preview on a non-HHU device, an invitation for purchase of a new license will be offered.

The exemplary help module 312 provides the user with information to assist the user in using the management engine 116.

In further embodiments, the management engine 116 may comprises further modules for management of content. For example, an editor module may be provided for editing the content of the library. Functions of the editor module may include creating edit points and chapters, providing time, and labeling and self affixing digital rights management and copy protection prior to burning of content to an updatable storage media.

In yet a further embodiment, a streaming module may be provided to allow full screen streaming of content (either in real time or time delayed) from a server (e.g., content server 104 and 106) that may be located anywhere in the world. The user may then watch the streaming content as well as store the content to the media player and/or the associated updatable storage media. For example, if the user purchases an enhanced updatable storage media for a particular base ball team for a current season, the user may stream each (licensed) game as it occurs or any time thereafter, and store the content on their computing device and/or updatable storage media. Alternatively, the user may purchase the stream concurrently or after viewing.

Referring now to FIG. 4A-4E, sample content pages of the updatable storage media (e.g., enhanced media disk 200) are shown. Upon an initiation of a selected storage media on a media player of the user computing device, an introductory content page or main menu 400, as shown in FIG. 4A, is presented to the user via the display device 120 (FIG. 1), according to one embodiment. The introductory content page 400 may comprise graphics related to the artist(s) or content of the selected storage media, or be customized to the genre of the updatable storage media. For example if the selected storage media is a CD for a particular artist, a photograph of the artist(s) or a cover of a latest album may be presented on the introductory content page 400. In a further example if the selected storage media is a DVD for a particular movie, an image from a scene of a movie may be presented on the introductory content page 400. It should be noted that the introductory content page 400 may comprise any graphics or data desired by the artist or manufacturer of the updatable storage media.

The introductory content page 400 also comprises a control strip 402, which may be located, in one embodiment, at a top of the page 400. The exemplary control strip 402 provides navigational and management control for the selected storage media on the media player. The components of the control strip 402 will be discussed in more detail infra.

In exemplary embodiments, the introductory content page 400 will further comprise various links 404 through which additional data related to the selected storage media may be accessed. In the present example, the introductory content page 400 is for a musical group, and the links comprise a media link 404a, a historical link 404b, an events link 404c, and a web links link 404d. Alternative embodiments may comprise more, less, or other links 404. Additionally, the various 404 links may have any name desired.

When the media link 404a is selected, the user display will present a media content page 410 comprising additional content as shown in FIG. 4B. In the present example, the additional content includes music videos and audio tracks for the artist which may be accessed via video links 412a and audio links 412b, respectively. The exemplary links 412 are “thumbnails” which provide a screenshot of the associated video or audio as well as a title of the video or audio. Upon selecting one of the links 412, the media player will present the video or audio. The media content page 410 further includes a main menu link 414 back to the introductory page 400 as well as the control strip 402. In alternative embodiments, the media content page 410 may be designed to present other media experiences to the user. For example, an enhanced media (corresponding to the updatable storage media) for a television show may provide outtakes from the show on the media content page 410. In exemplary embodiments, when a new video or audio is added to the enhanced media disk 200, a new video link 412a or audio link 412b will be added to the media content page 410.

When the historical link 404b (FIG. 4A) is selected, the management engine 116 presents the user with a history page 420 as shown in FIG. 4C. In exemplary embodiments, the history page 420 provides background information to the user. Thus, in the present example, a history of the artist is provided to the user. In an alternative example, the history page 420 may present information or further links to the making of a movie or television show if the enhanced media is a DVD for a movie or television show, respectively. Alternative embodiments may design the history page 420 to provide any information desired.

Returning to FIG. 4A, if the events link 404c is selected, the management engine 116 presents an exemplary events window 430 as shown in FIG. 4D. The events window 430 will provide information for past and/or upcoming events associated with the updatable storage media. In the present example, information for a concert after-party is provided. In further examples, a listing of other parties, concerts, artist appearances, and so forth may be provided. While the events window 430 is shown as an additional window on top of the introductory page 400, alternative embodiments may present the events page 430 as a replacement page to the introductory page 400. In this case, a main menu link will be provided to allow the user to return to the introductory page 400.

If a web links link 404d (FIG. 4A) is selected on the introductory page 400, the management engine 116 will present a web links page 440 as shown in FIG. 4E. The exemplary web links page 440 provides at least one URL 442 related to the selected media that the user may select from in order to be directed to the associated website. The exemplary web links page 440 also provides a main menu link 444 back to the introductory page 400.

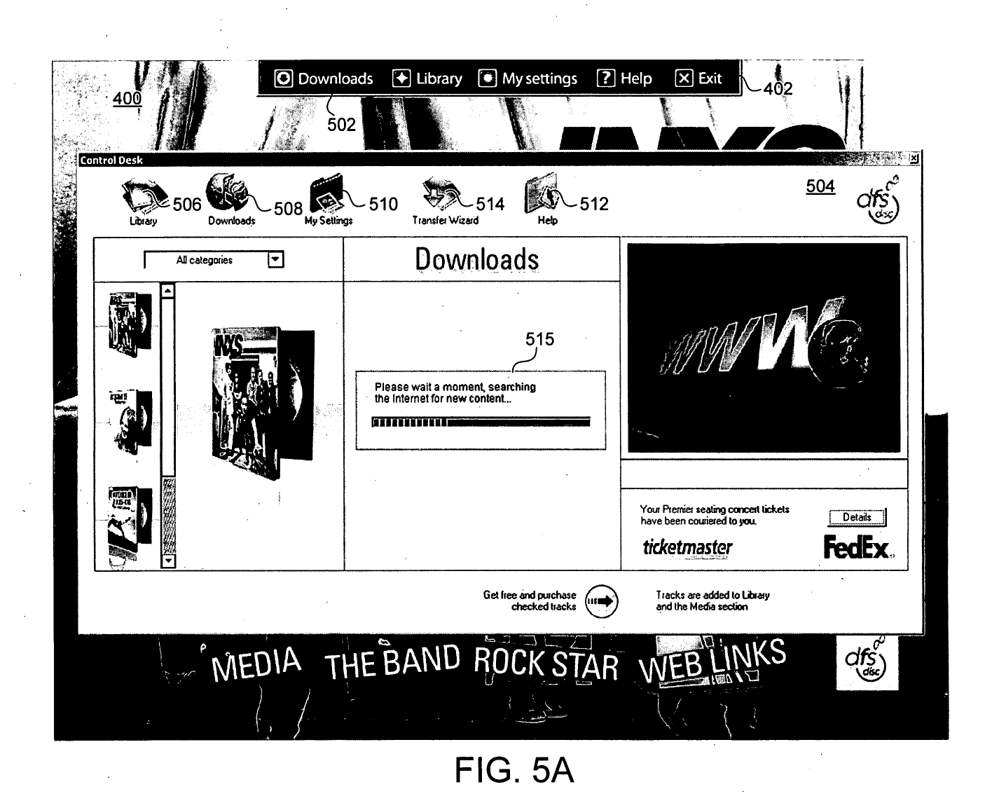

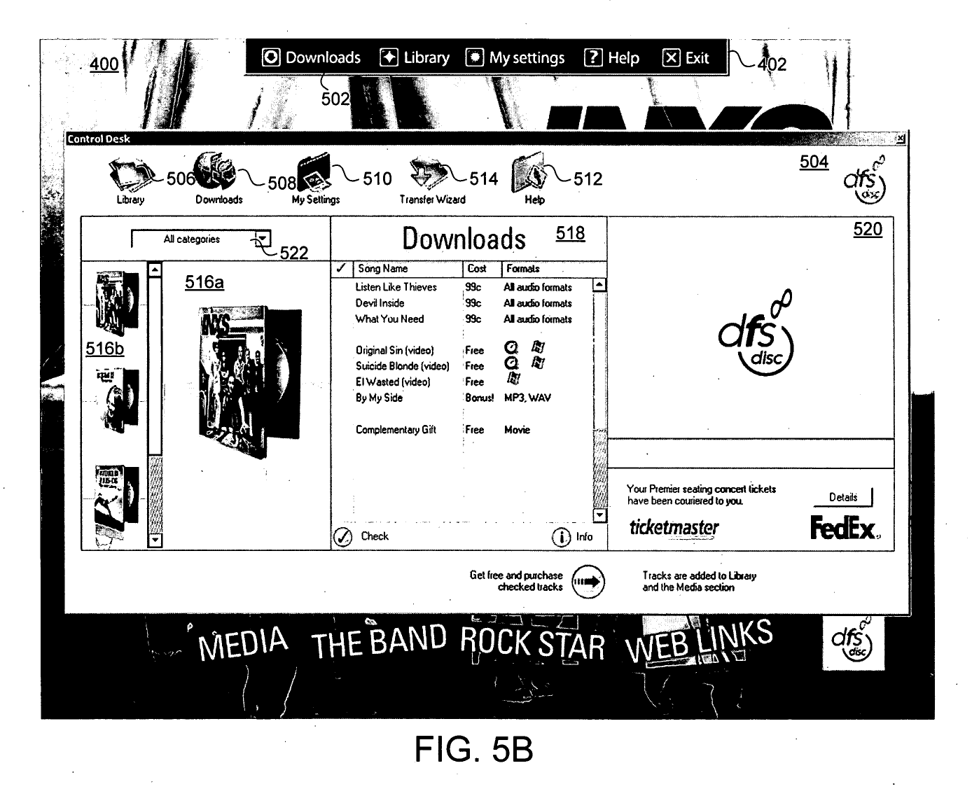

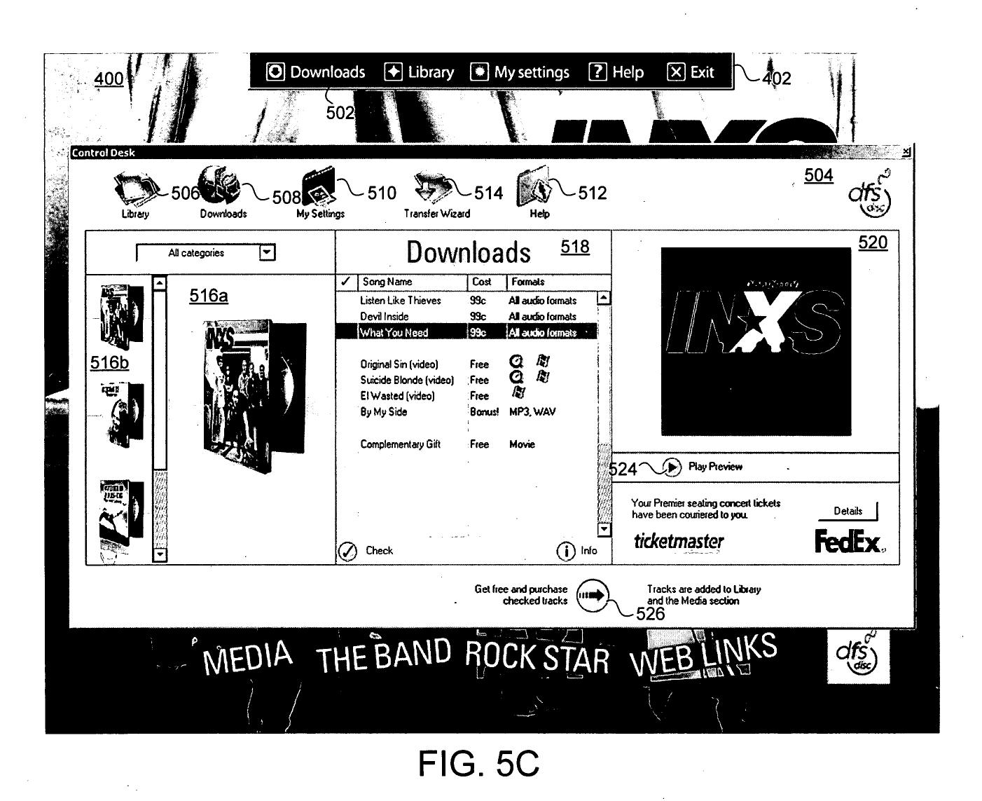

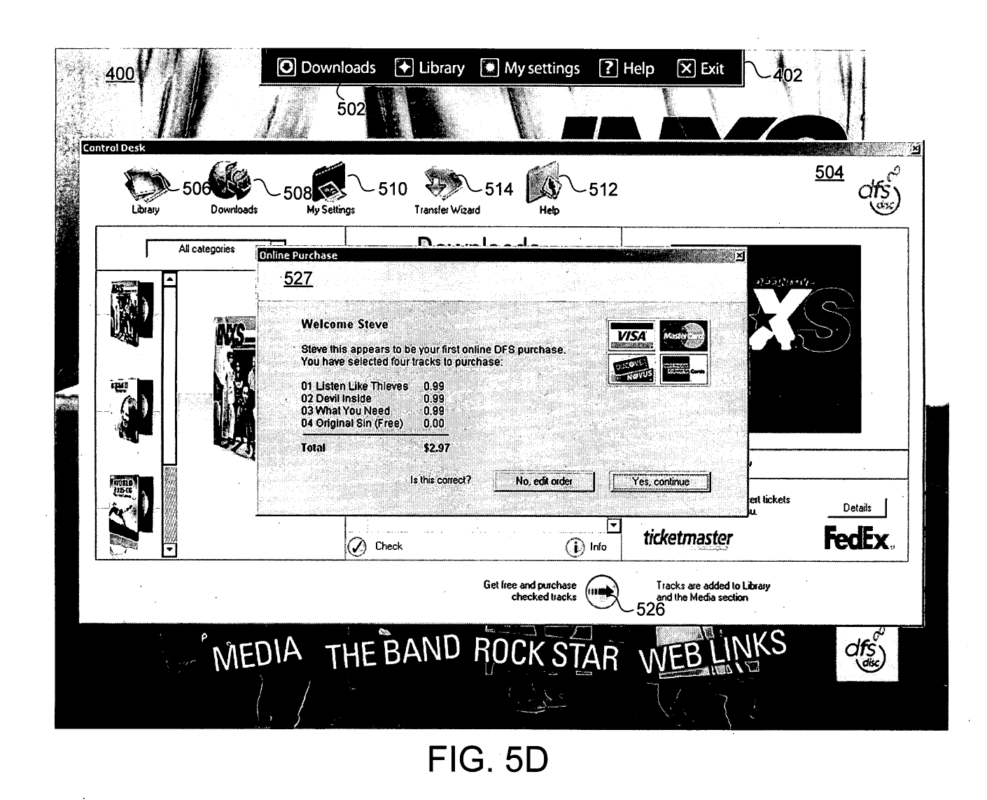

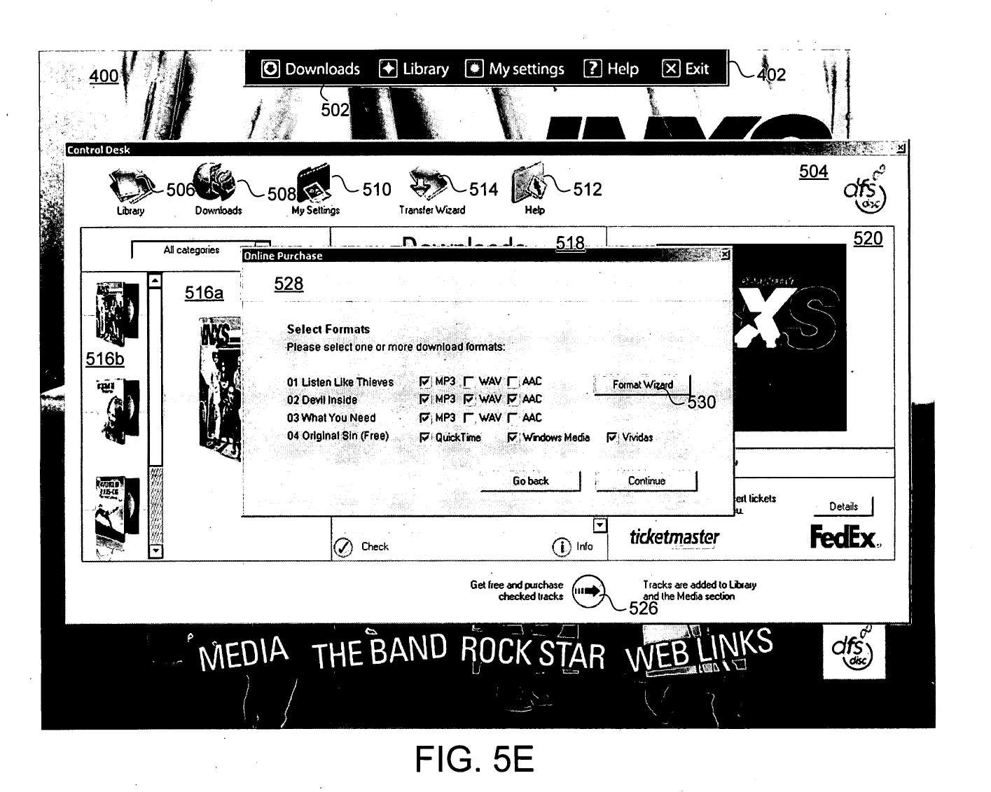

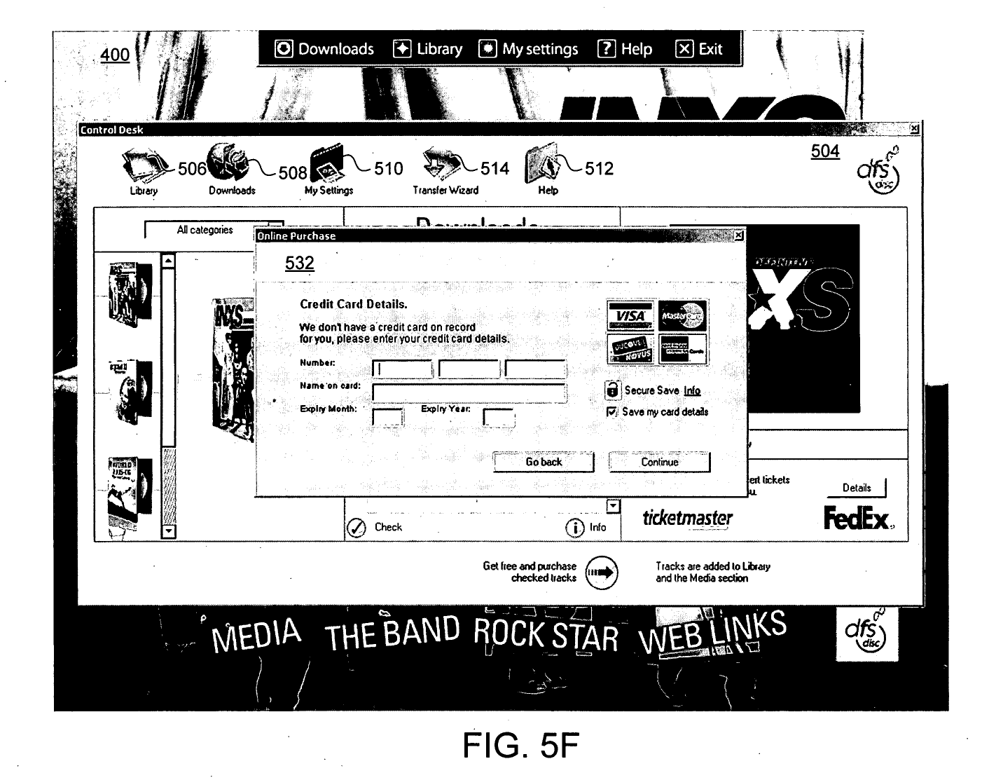

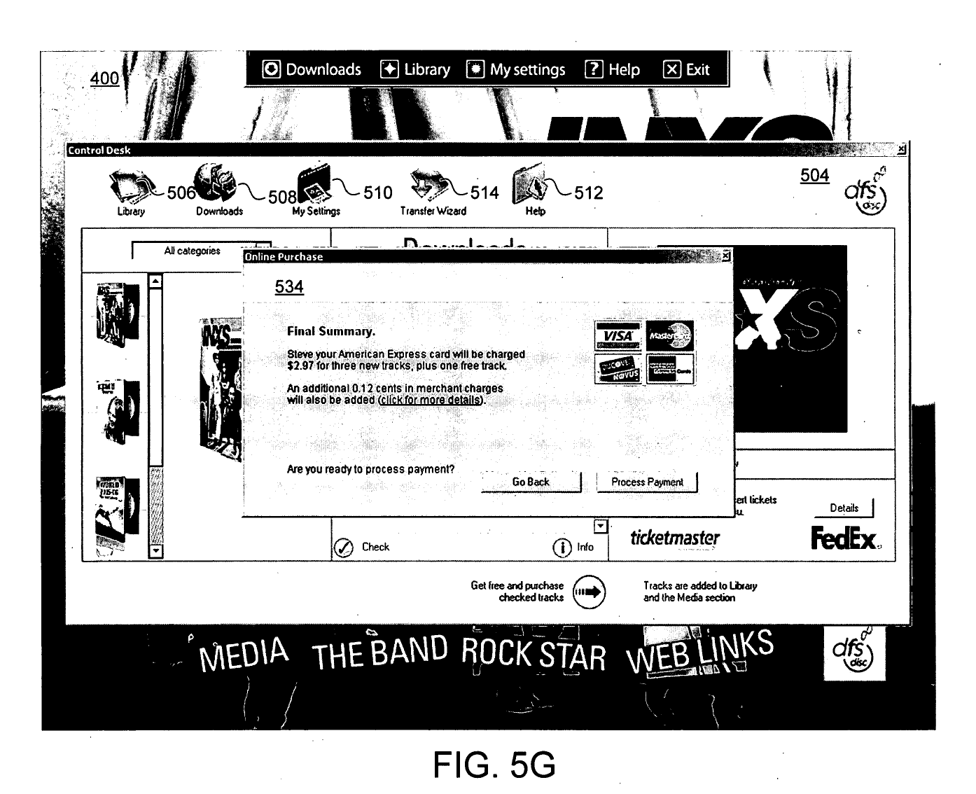

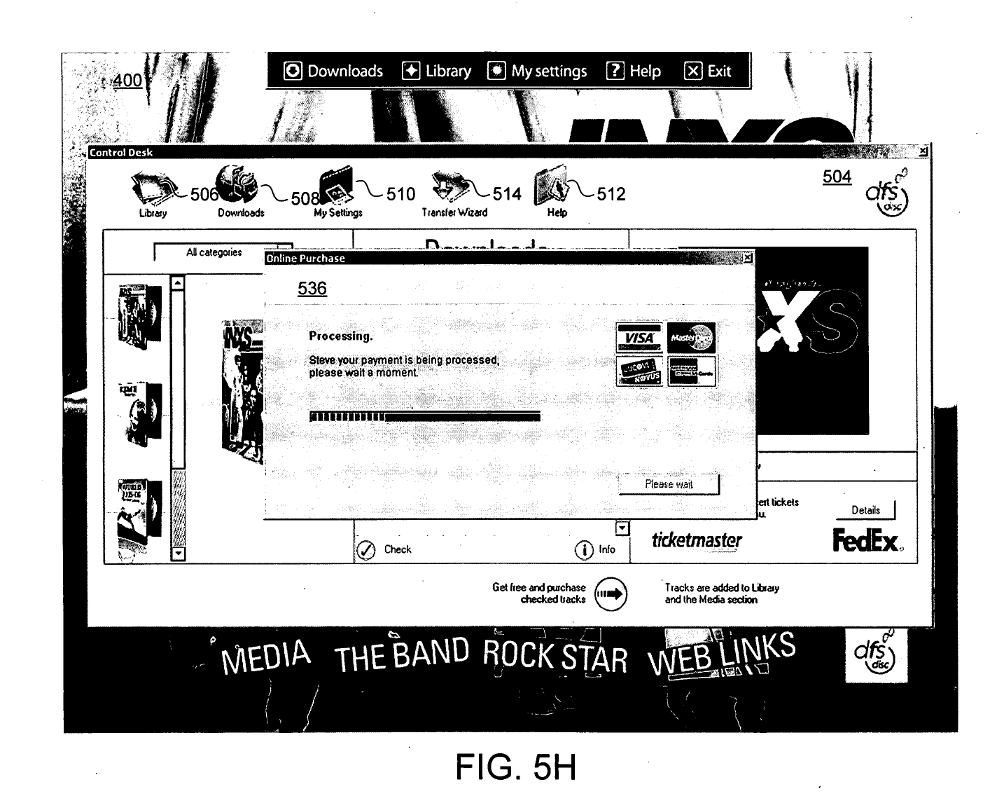

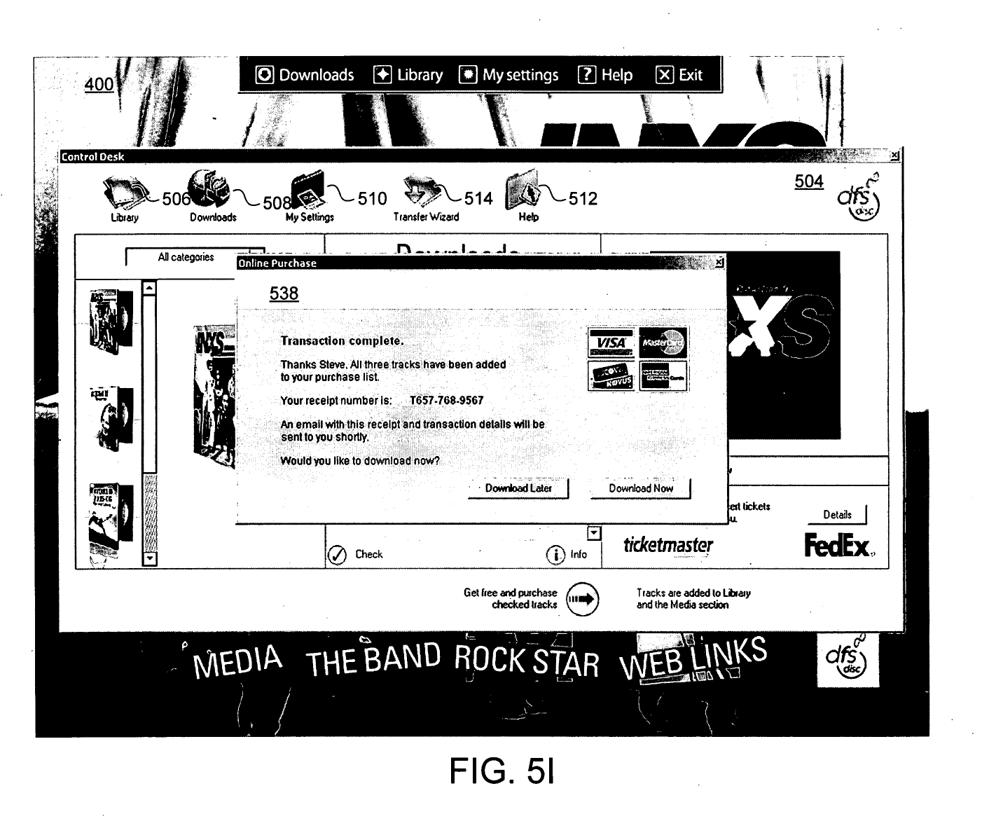

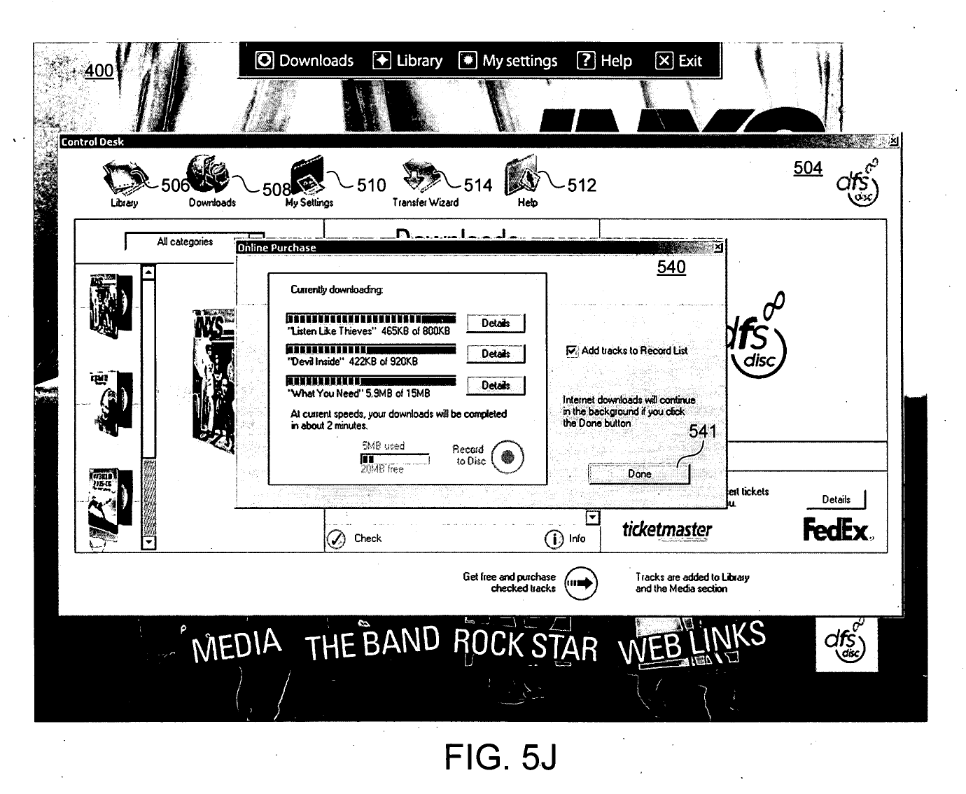

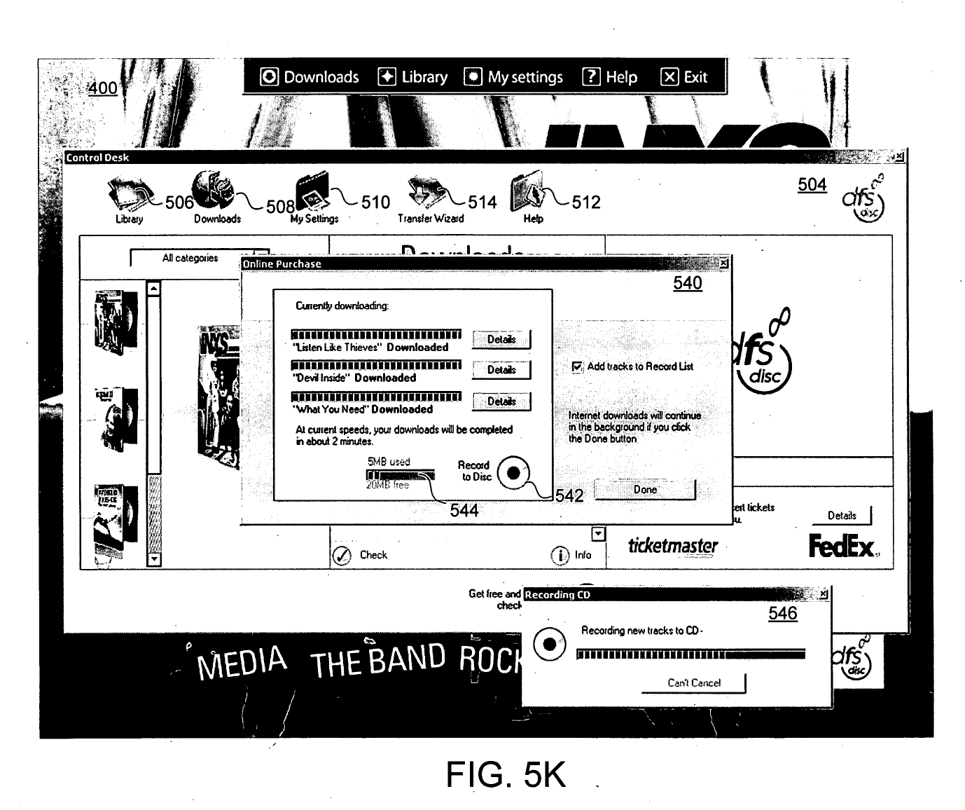

Referring now to FIG. 5A, the user may initiate a process to determine if new content is available for the enhanced media. In exemplary embodiments, the process is initiated by clicking a downloads selection 502 on the control strip 402. This action will bring up a control desk 504, provided by the management engine 116, which appears as a second window on top of introductory page 400. In alternative embodiments, the control desk 504 may appear as a replacement page to the introductory page 400. In yet a further embodiment the control desk 504 may be the introductory page 400. Furthermore, the control desk 504 may be initiated via other actions (e.g., select any selection from the control strip 402). In some embodiments, the control desk may be activated without the enhanced media being present.

The exemplary control desk 504 comprises some identical components as those found on the control strip 402, however, because the components are on the control desk 504, the user may easily access these components without having to leave the control desk 504. The identical components include a library icon 506, a downloads icon 508, a my settings icon 510, and a help icon 512. The control desk 504 also provides a transfer wizard icon 514. The transfer wizard icon 514 activates the transfer module 310 (FIG. 3) which is located in the management engine 116. The transfer module 310 allows for simplified transfer of content files from one hardware device to another. The transfer module 310, when activated, will provide a list of hardware to record from and to, which the user may simply select from. The transfer module 310 will then automatically determine and convert the file to an appropriate file format and send the file to the new hardware device (e.g., via e-mail or Internet). The control desk 504 may also provide a burn icon (not shown) which activates the burn module 314 to storage content onto the enhanced storage media.

As shown in FIG. 5A, the activation of the downloads selection 508 brings up a small, status display 515 which shows progress of a search for new content. In exemplary embodiments, the search is of coupled content servers (e.g., content servers 104 and 106 of FIG. 1).

Referring now to FIG. 5B, the exemplary control desk 504 is further divided into a plurality of display sections including a media section 516, an action section 518, and a preview section 520. Alternative embodiments may divide the control desk 504 into as many display sections as desired.

The media section 516 is further divided into a current media display 516a and a media selection display 516b. The current media display 516a provides an image of the currently selected media of the user computing device (associated with the updatable storage media). In the present example, the selected media is a particular CD for INXS. The media selection display 516b provides a scrollable, graphical list of available enhanced media/updatable storage media (which the user has purchases and stored onto their media player) the user may select from should the user decide to access a different enhanced media/updatable storage media. In order to make navigation of the graphical list more efficient, a category selector 522 is provided from which the user may select a particular category to display a graphical list of. In exemplary embodiments, the categories comprise music, movies, television shows, sporting events, and so forth. Any category of content is within the scope of the present invention.

When the user initiates a process to check for new content for the selected enhanced media/updatable storage media (i.e., the INXS CD), the download module 308 (FIG. 3) matches an associated disk identification number and checks for new or updated content (e.g., new music track or sports video segment). A scrollable list of currently available downloads is then presented in the action section 518. In exemplary embodiments, the user computing device on which the media player is operating will be coupled to the Internet and access a content provider associated with the selected enhanced media. The content provider (then determines what content is available which is not currently stored on the media player and/or updatable storage media. In an alternative embodiment, the content provider provides a complete list of available content, and the download module 308 determines those content which are not currently stored on the media player and/or updatable storage media. A list of the available content is then presented in the download action section 518. In the present example, track titles, cost for download, and download formats available are listed. Alternative embodiments may comprise more, less, or other information fields. Because some available content may already be included in the purchase price of the original updatable storage media, those content will be free of charge. Other content may not be included in the original purchase price and thus a license is not given for download onto the media player and updatable storage media. In this situation, the user must pay for the new content before download is authorized.

As shown in FIG. 5C, the user may select any of the available content for download. The content may be selected via highlighting the desired content, as shown. Alternatively, the user may check a box next to the desired content or perform any other action to indicate a content selection. Any number of selections may be made at any time. Thus, the user may select to download more than one track via the action section 518.

In an exemplary embodiment, the user may play a preview of a selected track in the preview section 520 by activating a “play preview” button 524. For example, if the selected content is a song, the preview may be an audio sample or a music video of the song. Alternatively, if the selected content is a next installment of a baseball game, for example, the statistics from the game may be displayed in the preview section 510. The preview may be any sample content associated with the selected content track the content provider wants to provide.

When the user is finished selecting the available content and activates a purchase button 526, a summary window 527 as show in FIG. 5D is provided. The exemplary summary window 527 will summarize the items the user indicates to be purchased, the cost of each item, and a total amount. If the order is incorrect, the user has an opportunity to edit the order using, for example, a B2C application provided in the management engine 116.

If the order is correct, a formats window 528 is provided as shown in FIG. 5E. Various contents may be available in a plurality of formats such as MP3, WAV, AAC, QuickTime, Windows Media, Vividas, and so forth. In the present example, the user selects to purchase four new content tracks. All four tracks are shown with available format types. According to exemplary embodiments, the format type may be automatically selected based on preferences in the “my settings” as determined or stored by the settings module 304 (FIG. 3). The user may also manually select or change the format(s) for the content.

In exemplary embodiments, a format wizard 530 is provided. The format wizard 530 will determine the format(s) required for the media player and/or the updatable storage media. Thus, a user unfamiliar with format types can use the assistance of the format wizard 530 to select the proper format types.

Once the format(s) are determined, a payment window 532 is next presented to the user as shown in FIG. 5F. The payment window 532 may accept payment via credit cards, debit cards, electronic fund transfer, Internet payment solutions (e.g., PayPal), or any other form of payment. In the present example, a credit card payment window 532 is shown. The exemplary credit card payment window 532 provides fields for entry of a credit card number, name on card, and expiration data. In exemplary embodiments, payment information may be stored in the users preferences, and the settings module 304 (FIG. 3) or payment gateway module will access the payment information and automatically fill in the fields on the payment window 532.

Once format types and payment have been provided, a final summary window 534 (FIG. 5G) is provided. The final summary window 534 is a confirmation that the payment information is received and will be processed upon user agreement to the charges. This final summary window 534 provides a final opportunity for the user to edit their order. Should the user decide to process the order, a process order window 536 (FIG. 5H) will appear and provide a status of the payment processing.

Once the payment processing is complete, a transaction completion window 538 (FIG. 5I) will provide a confirmation of the order. In exemplary embodiments, the confirmation will include a summary of the number of tracks purchased, a receipt number, and a request for instructions as to when to download the purchased tracks. Alternative embodiments may provide additional or other information in the transaction completion window 538.

Although the present example provides the formats window 528 before the payment window 532, alternative embodiments may provide the payment window 532 prior to the display of the formats window 528. In further embodiments, more of few windows during the purchase and download process may be provided, and the windows may be in any order.

Referring now to FIG. 51, when the user downloads the purchased tracks, a download status window 540 is provided. The download status window 540 may also display an estimated time to complete the download. As shown in FIG. 5J, one or more content tracks may be downloaded simultaneously. Furthermore, the download can continue in background if the user selects the “done” button 541. Once the download is complete, the new content is now available on the media player.

The user may also elect to download and store (i.e., burn) the content onto the associated updatable storage media in order to maintain a “hard copy” of the content. The process may be initiated by activating a “record to disc” button 542 as shown in FIG. 5K. In an alternative embodiment, the media player may automatically burn the new content onto the updatable storage media without user intervention. In yet another alternative embodiment, the new content may be downloaded directly to the updatable storage media without storage on the media player storage device 118 (FIG. 1). Further, a space indicator 544 shows an amount of storage space used and available on the associated updatable storage media. Once the “record to disc” button 542 is activated, a record status window 546 will indicate the progress of the recording.

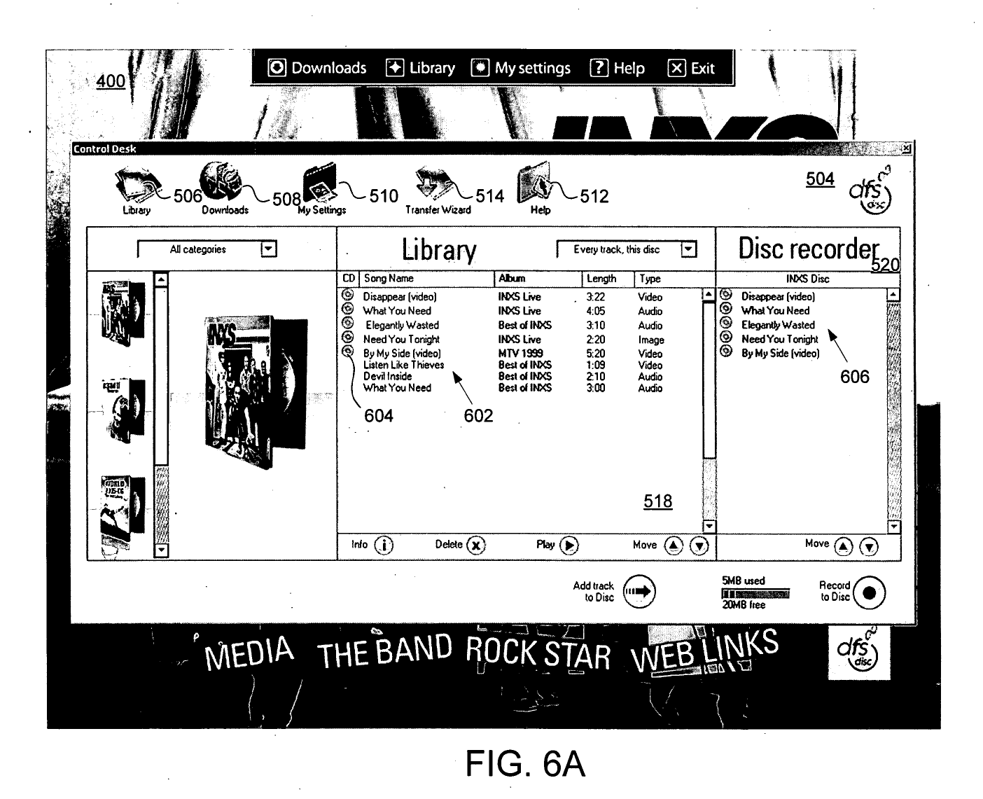

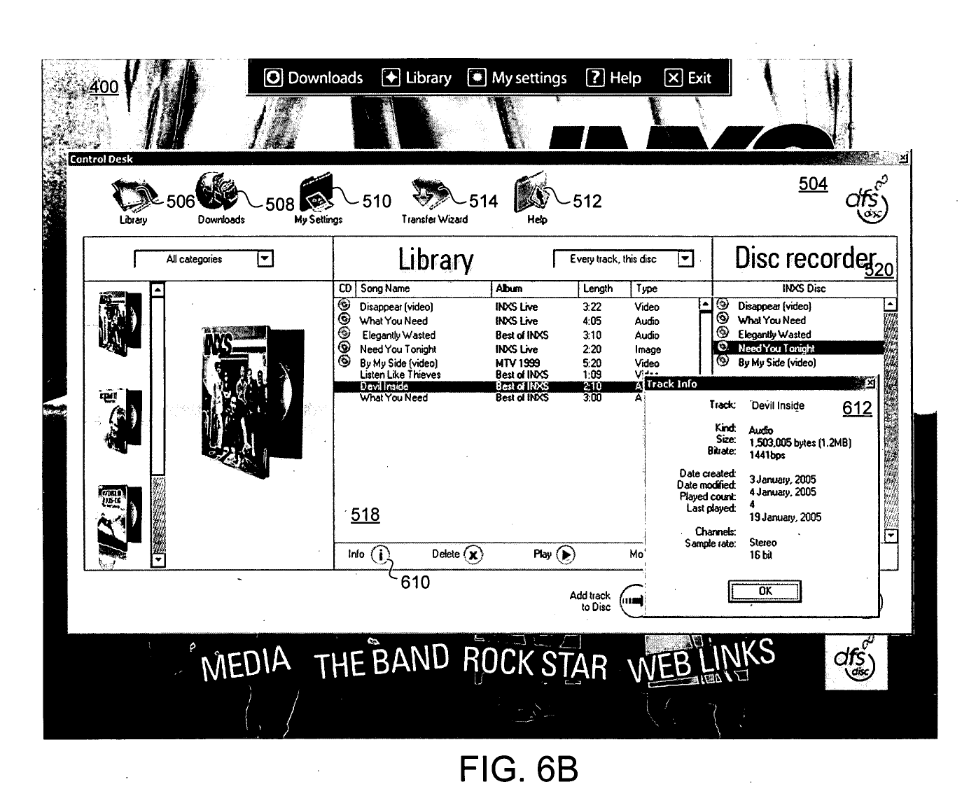

In exemplary embodiments, the new content is automatically incorporated into the library of the media player. Thus, when the user activates the library icon 506, for example, a library listing 602 associated with the currently selected enhanced media is displayed in the action section 518 as shown in FIG. 6A. The library listing 602 is determined by a search of the coupled storage device 118 (FIG. 1) by the library interface module 306 (FIG. 3). In the present example, the library listing 602 presents the list of all INXS tracks stored on the computing device (i.e., all content for the artist are shown) as indicated by the various albums from which the tracks are associated with. Alternative embodiments may only show the content associated with the selected enhanced media (i.e., currently selected CD). Additionally, the library listing 602 may provide length of each track and the type of content each track is (e.g., video, audio).

In one embodiment, tracks from associated updatable storage media (e.g., CD) are indicated with a CD icon 604, while tracks from other sources do not have a CD icon.

The library listing 602 may also be managed by the user (via the library interface module 306 of FIG. 3). Thus, the user is able to rename, rearrange, or delete previously stored tracks. The user may also prepare a list for recording. As shown in FIG. 6A, the preview section 520 now provides an area for ordering content (via a order list 606) to be downloaded and stored to a further device (via the download module 308 or burn module 314 of FIG. 3). Any number of content tracks may be downloaded to any other authorized devices. Thus, the present order list 606 may record the listed contents to the associated updatable storage media (i.e., CD) or any hardware devices within the users designated hardware home universe (HHU), for example.

Referring now to FIG. 6B, information on each track in the library may be obtained by selecting a track and activating an “info” button 610. This will bring up a track info window 612 which provides details with regards to the selected track.

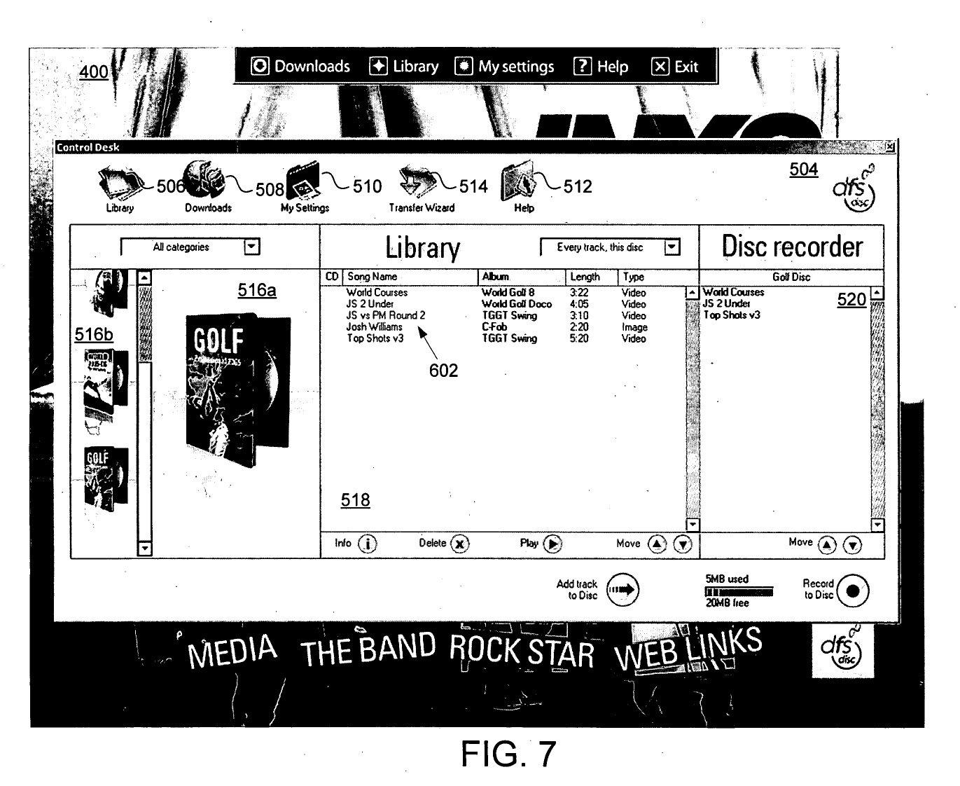

As previously indicated, embodiments of the present invention allow for the management of any form of digital media. While the present description contains mostly examples of music media, alternatively, video, movie, television, sporting event, and video game media, for example, can all be managed by the management engine 116. As shown in FIG. 7, a user accesses a sporting event updatable storage media using the same management user interface. In exemplary embodiments, the user scrolls through the list of available enhanced media in the media selection section 516b and selects a golf media, an image of which is shown in the current media section 516a. A list of corresponding associated content is provided in the library listing 602.

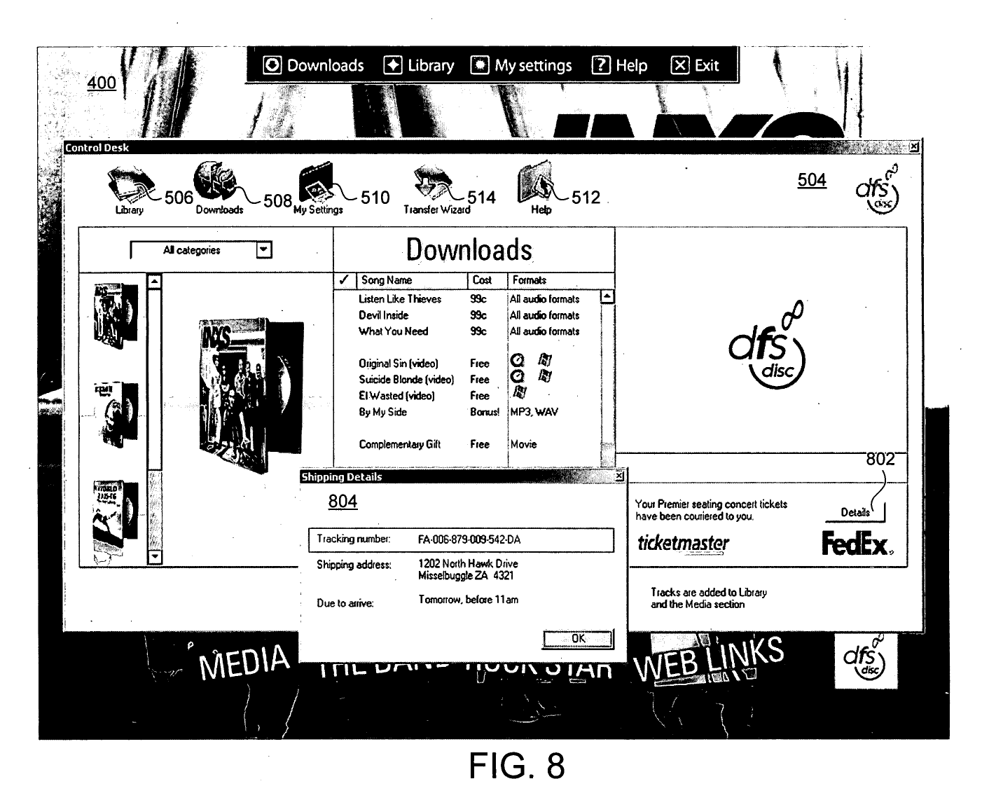

Referring now to FIG. 8, the management engine 116 (FIG. 1) may also provide for management of purchases related to the associated enhanced media (i.e., updatable storage media). For example, when visiting the events page 430 (FIG. 4D), the user may have purchased tickets to an upcoming concert. The management engine 116 will track the shipping of the tickets. The user selects a “details” button 802, and a shipping details window 804 is provided.

The invention has been described with reference to exemplary embodiments. It will be apparent to those skilled in the art that various modifications may be made and other embodiments can be used without departing from the broader scope of the invention. For example, alternative forms of disk media may be used in the present invention. Therefore, these and other variations upon the exemplary embodiments are covered by the present invention.

What is claimed is:

1. A system for managing content associated with updatable storage media, comprising:
a content interface module configured for providing a user interface for managing the content;
a library interface module configured to access stored content and provide selected content via the user interface; and
a download module configured to access new, available content associated with the updatable storage media which may be downloaded and stored onto the updatable storage media.

2. The system of claim 1 further comprising a network interface configured to access content servers having the new, available content.

3. The system of claim 1 further comprising at least one storage device coupled to the library interface module and configured to store the content associated with the updatable storage media.

4. The system of claim 1 further comprising a settings module configured to provide user preferences.

5. The system of claim 1 further comprising a transfer module configured to transfer content to at least one other computing device via a simplified transfer interface.

6. The system of claim 5 wherein the one other computing device is within the user's designated hardware home universe.

7. A method for managing content associated with updatable storage media, comprising:
receiving a selection for content associated with an updatable storage media from a user;
accessing the selected content associated with the updatable storage media;
providing a user interface on a display device, the user interface providing the selected content; and
determining if new content associated with the updatable storage media is available.

8. The method of claim 7 further comprising allowing download and storage of the new content associated with the updatable storage media.

9. The method of claim 8 further comprising accessing licensing data associated with the updatable storage media to determine download permissions.

10. The method of claim 8 further comprising determining at least one format in which to download the new content.

11. The method of claim 10 wherein the determining is performed by a format wizard.

12. The method of claim 8 further comprising downloading and storing the new content into the storage device of the user computing device.

13. The method of claim 8 further comprising downloading and storing the new content onto the updatable storage media.

14. The method of claim 7 further comprising sending payment data related to a purchase of the new content.

15. The method of claim 7 wherein determining if new content is available comprises comparing a unique disk identifier of the updatable storage media.

16. The method of claim 7 further comprising providing a preview of new content to the user.

17. The method of claim 7 further comprising downloading a management engine from the updatable storage media.

18. The method of claim 7 wherein the user interface comprises a link accessing additional media content associated with the updatable storage media.

19. The method of claim 7 wherein the user interface comprises a link accessing historical information associated with the updatable storage media.

20. The method of claim 7 wherein the user interface comprises a link accessing events associated with the updatable storage media.

21. The method of claim 7 wherein the user interface comprises a link accessing URLs associated with the updatable storage media.

22. The method of claim 7 further comprising providing a control strip on the user interface for managing content.

23. The method of claim 7 further comprising displaying an image associated with the selected updatable storage medium.

24. The method of claim 7 wherein receiving a selection for content further comprises displaying a list of enhanced media from which the user may make their selection.

25. A computer readable medium having embodied thereon a program, the program providing a method for managing content associated with updatable storage media, the method comprising:
receiving a selection for content associated with an updatable storage media from a user;
accessing the selected content associated with the updatable storage media;
providing a user interface on a display device, the user interface providing the selected content; and
determining if new content associated with the updatable storage media is available.

26. The computer readable medium of claim 25 wherein the method further comprises allowing download and storage of the new content associated with the updatable storage media.
